(19) United States
(12) Patent Application Publication
(10) Pub. No.: US 2002/0089519 A1
(43) Pub. Date: Jul. 11, 2002

(54) Systems and methods for creating an annotated media presentation

(75) Inventors: David Betz, Bedford, NH (US); Mindy Lam, Los Altos, CA (US); James Grunke, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VM Labs, Inc., Mountain View, CA

(21) Appl. No.: 10/040,741

(22) Filed: Jan. 4, 2002

Related U.S. Application Data
(60) Provisional application No. 60/259,911, filed on Jan. 5, 2001.

(51) Int. Cl. G09G 5/00

(52) U.S. Cl. 345/634

(57) ABSTRACT

Systems and methods for creating and playing annotated media presentations are provided. The methods include creating a commentary including annotations regarding a particular video title, reverse compiling the commentary, editing the commentary, and compiling the commentary. The systems include hardware and software for creating commentaries and hardware and software for presenting the created commentaries.

### CROSS-REFERENCES TO RELATED APPLICATIONS

This application claims the benefit of U.S. Provisional Application No. 60/259,911 filed of Jan. 5, 2001.

This application is being filed with related U.S. Patent Applications: U.S. Patent Application No. ______ (Attorney Docket No. 19223-001610US), entitled “Systems and Methods for Creating a Video Montage from Titles on a Digital Video Disk”; and U.S. Patent Application No. ______ (Attorney Docket No. 19223-001510US), entitled “Systems and Methods for Creating Single Video Frame With One or More Interest Points” both filed on a date even herewith and each incorporated herein by reference for all purposes.

### BACKGROUND OF THE INVENTION

This invention relates generally to digital video disk (DVD) technology. More particularly, this invention relates to providing unique playback experience to a viewer.

In the past, audio/visual (AV) programs such as movies, television shows, music videos, video games, training materials, etc. have typically involved a single play version of the program. The user would begin play of the program and watch the program from beginning to end. A single presentation was implemented in displaying the program. A user did not have any option to view the program from a different angle, with a different soundtrack, in a different language, with subtitles, etc. because the video could not accommodate multiple options.

However, with the introduction of DVD technology, a user now has greater number of unique options to choose from. A storyline in a movie, for example, can be shot from different angles and stored as different versions on a DVD storage medium. Similarly, a movie might be sold with optional language tracks. Thus, a viewer could decide to watch the movie with a French language track rather than English, for example. As another example, a movie might be presented with different endings. Thus, a user could select a preferred ending option before playing the movie.

In addition, DVD technology provides a viewer with unique menuing options prior to the actual play of the DVD. Such menuing options may include the ability to view deleted scenes, the movie trailer, a director narrative, the making of special effects, or actor biographies, to name a few. Menuing options may provide “behind the scenes” insight into the movie or provide the viewer with information reorganized in a format that is otherwise not available. Anything that enhances the story and adds to the all-around movie environment creates a more enjoyable movie viewing experience for the viewer.

Thus, there is a need for a device and method which is capable of creating and providing unique playback options to a viewer of a DVD. There is also a need for a system and method that allows a creator of a DVD title to provide the viewer with options that may be of interest without disturbing the integrity of the titles contained on the DVD itself.

### SUMMARY OF THE INVENTION

The present invention provides systems and methods creating, editing and/or presenting commentaries in association with portions of video title(s).

Some embodiments of the invention include methods incorporating annotations with a video title. Such embodiments can include identifying a segment of a video title and providing annotations regarding the segment. The annotation are formatted and stored as computer readable op-codes. The stored computer readable op-codes form a commentary that is executable to present a displayed, annotated video presentation.

Other embodiments of the invention provide systems for creating commentaries associated with video titles. Such systems include displays for displaying the created commentary and/or the unannotated video title. The systems utilize an interpreter for receiving commands from an input device. The commands can be add verbal commands, add graphic commands and add vista point commands. Each of the commands is associated with a video title presented on the display. The system also includes a memory element that includes software operable to receive the commands from the interpreter, indicate a segment of the video title, and format the commands as a computer executable commentary associated with the segment of the video title.

Yet other embodiments of the invention provide systems for presenting commentaries associated with one or more video titles. The system includes a memory storage device with a commentary and a video title. In addition, the system includes a microprocessor based player for retrieving portions of the commentary and portions of the video title and for causing a presentation to display. The presentation comprises images from the video title and annotations directed from the commentary.

Other and further advantages and features of the invention will be apparent to those skilled in the art from a consideration of the following description taken in conjunction with the accompanying drawings wherein certain methods and apparatuses for practicing the invention are illustrated. However, it is to be understood that the invention is not limited to the details disclosed but includes all such variations and modifications as fall within the spirit of the invention and scope of the appended claims.

### BRIEF DESCRIPTION OF THE DRAWINGS

FIG. 1 is a system drawing for implementing the present invention;

FIG. 2 is a block diagram of Nuon™ system;

FIG. 3 is a block diagram of a media processing system;

FIG. 4 is a block diagram of a development system for creating work-in-progress and run time files in accordance with the present invention;

FIG. 5A shows a video montage created from several video clips;

FIG. 5B illustrates an individual video clip;

FIG. 6 illustrates portions of a video title being clipped and, in some instances, manipulated to create vista points;

FIG. 7 is a detailed view of a vista point including added 2D graphics; and

FIGS. 8A and 8B are flow charts outlining the steps for creating a commentary related to particular video titles and segments thereof.

### DESCRIPTION OF THE SPECIFIC EMBODIMENTS

The invention provides exemplary systems and methods for creating a compilation of video clips and an associated enhancements related to one or more titles on a DVD. The video clips can be extracted from a completed film, or video title, using software and/or hardware systems. Further, the video clips or “viddie clips” may be taken from one or more video titles available on a DVD including, but not limited to, the main feature, theatrical trailers, deleted scenes, and alternate views. In some embodiments, the associated enhancements can be annotations, including, but not limited to, audio wave files, 2D graphics, text strings, and zooming and/or panning of the video clips. The annotations are assembled into a commentary that can be used or executed in relation to the video title(s).

As used herein, the term “viddie montage” may be used to refer to a compilation of video clips. A viddie montage is a thematic collection of shots, scenes or sequences, and is typically made up of viddie clips (segments of a video title). Individual video clips may be referred to as “viddie clips.” A viddie clip is the smallest unit within a viddie montage, and can be an individual shot, scene, or a sequence defined by an “in” and an “out” runtime. As one skilled in the art can appreciate, the terminology used to identify and describe the individual clips and the compilation should in no way limit the scope of the invention.

As used herein, a “hyper slide” designates an frame of video, or any other image or graphic associated with a particular scene in a video title. For example, a hyper slide may include a single frame of video showing a costume worn by an actor in a video title. Such a hyper slide may be an actual image taken from the video title, or an image made of the actor apart from the video title.

As used herein, the term “commentary” refers to a byte stream of op-codes and associated parameters executable to display all or portions of a video title(s) with additional enhancements. An executable commentary exists as a byte stream of computer readable hexadecimal numbers, while a reverse compiled byte stream exists as a human readable test file describing the series of op-codes and parameters in the commentary. Such a reverse compiled byte stream can be referred to as a textual commentary. As one skilled in the art can appreciate, the terminology used to identify and describe the executable byte stream and the text representation of the byte stream should in no way limit the scope of the invention.

Moreover, the invention described herein will occasionally be described in terms of a NUON™ system. As one skilled in the art can appreciate, any software enhanced digital playback device system may be used, but for ease of description and general understanding, the following description will be described in terms of a NUON™ system.

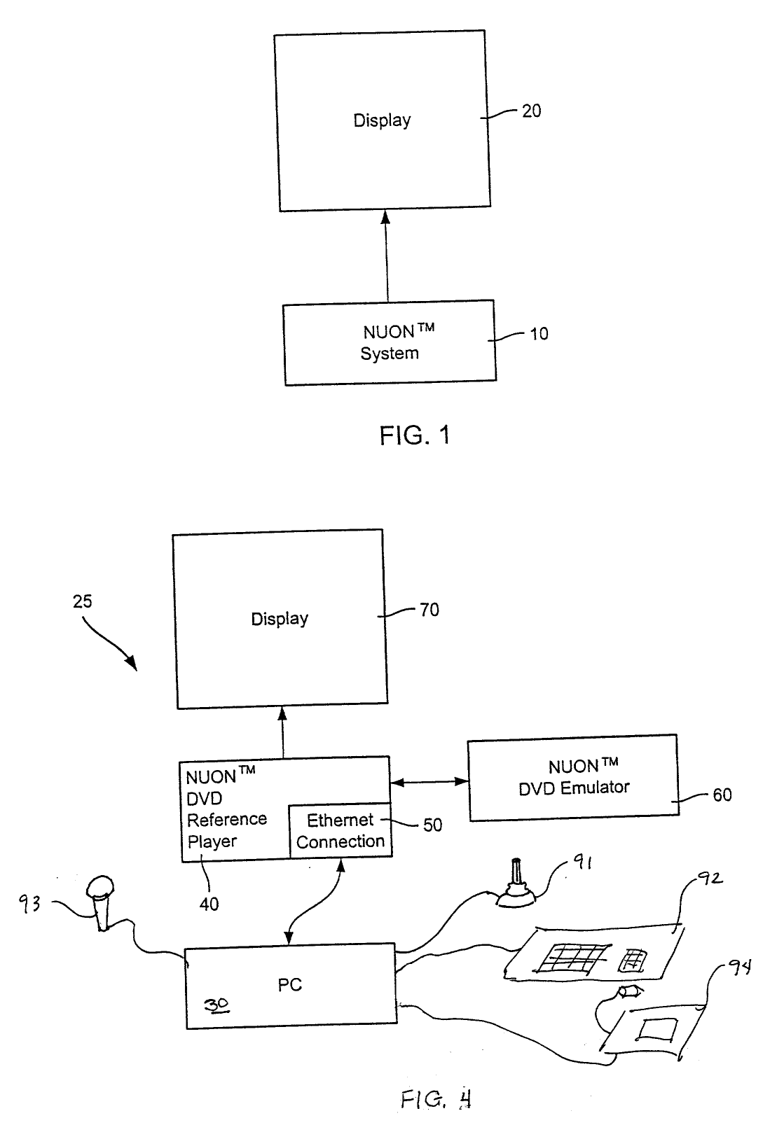

FIG. 1 illustrates a basic configuration for implementing the various embodiments of the present invention. Other configurations may be utilized, however, the illustrated configuration provides a simple yet effective implementation. As shown, NUON™ system 10 is a combination programmable single chip media processor with system and application software that enables hardware manufacturers to develop sophisticated and highly interactive digital video playback device. Digital playback devices may include, but are in no way limited to, DVD players and set-top boxes to name a few. As shown, system 10 is coupled to display 20. System 10 can be a multi-chip media processor, a single chip media processor with multiple internal paths, or a single chip media processor with proper memory buffering to handle multiple data streams simultaneously.

In one embodiment, system 10 comprises a NUON™ DVD system having a software layer running in the background. The software can be similar to the operating system on a personal computer (“PC”). The software allows enhanced digital video discs to take control of the system in a similar manner to a software application that operates on a PC. Since it is software based, system 10 is programmable in much the same way as a general purpose microprocessor-based computer. Therefore, the system is easily improved and expanded.

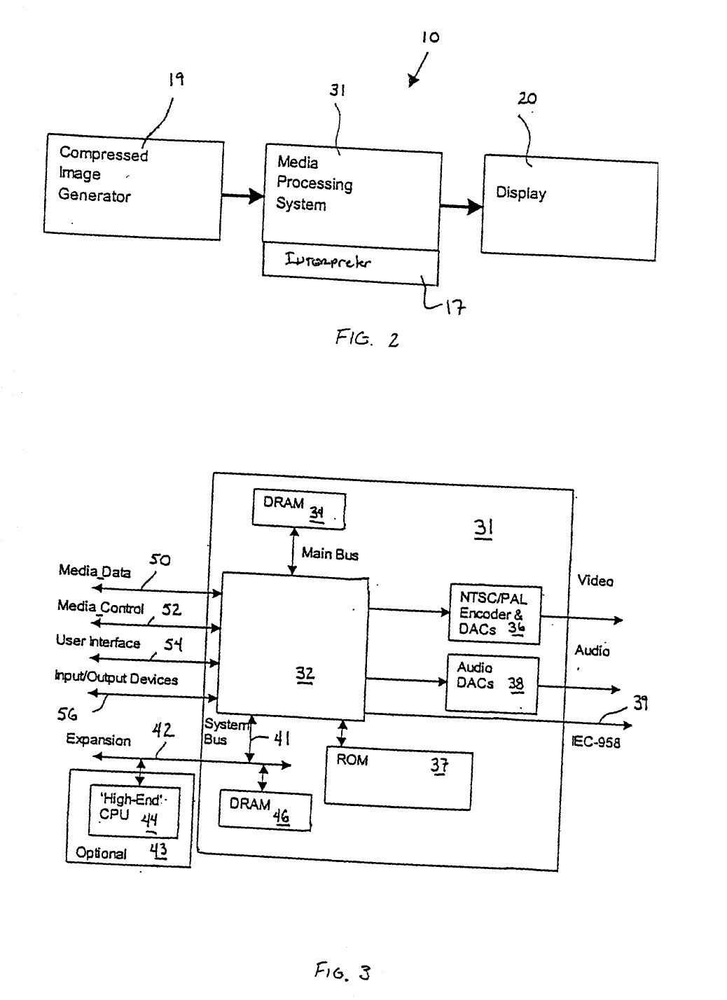

FIG. 2 is a general block diagram of an exemplary embodiment of a system 10 configured to process commentaries created in accordance with the present invention. The system preferably includes a compressed image generator 19, such as a hard disc drive, a cable television system, a satellite receiver, or a CD or DVD player, that can generate or provide a digital compressed media stream. System 10 also includes a display 20 for displaying decompressed full-motion images. The compressed media stream, that may include audio and visual data, enters a media processing system 31 configured to decompress the compressed media stream. In addition, media processing system 31 also may process digital data contained in the compressed data stream or in another storage device or digital data source, at the same time as it decompresses the compressed media stream, thus generating other types of media data that may be used with the decompressed media stream. For example, an interactive, color, full motion video game may be created. Once all of the data has been decompressed and processed, the data is output to display 20 for viewing. For a cable or satellite television system, media processing system 31 simply may decompress the incoming compressed digital data and output the images onto display 20, which in accordance with one embodiment of the present invention, may be a television screen.

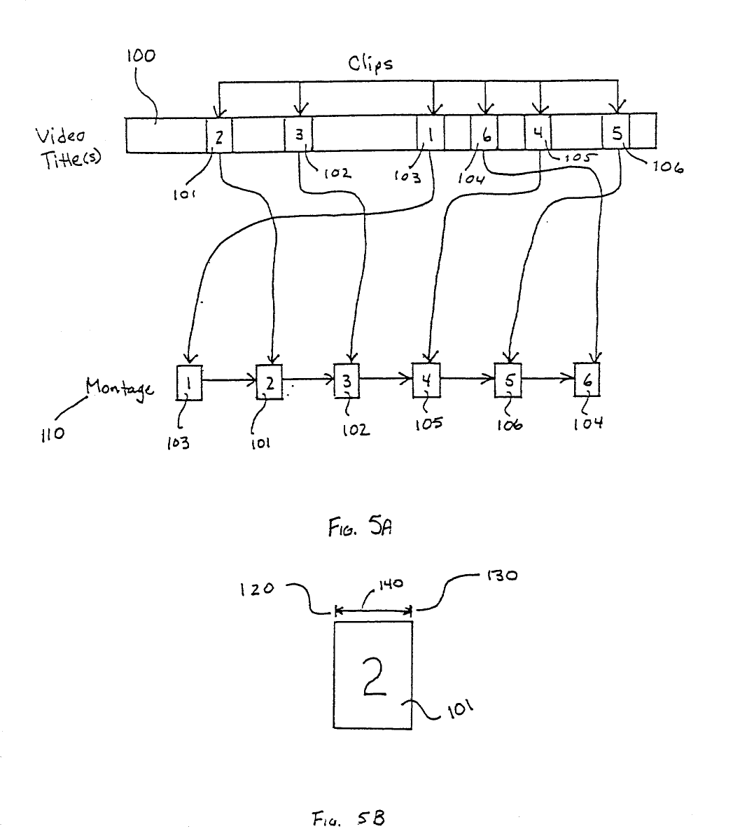

FIG. 3 is a block diagram of the architecture of media processing system 31 in accordance with one embodiment of the present invention. Media processing system 31 includes a media processor 32, which can perform a number of operations, such as decompressing compressed video data, processing digital data that may include the decompressed video data and/or other digital data to generate full-motion color images, and controlling other operations within media processing system 31. Media processor 32 may be fabricated on a single semiconductor chip, or alternatively, the components of media processor 32 may be partitioned into several semiconductor chips or devices.

Additionally, media processing system 31 can include multiple media processors 32 to handle a variety of simultaneous data streams. The multiple media processors 32 can be incorporated on a single chip or implemented using multiple chips. It should thus be recognized that a single data stream and multiple data streams may be manipulated and/or displayed in accordance with the present invention.

Media processing system 31 also preferably includes one or more storage devices 34, 46, such as DRAM, SDRAM, flash memory, or any other suitable storage devices for temporarily storing various types of digital data, such as video or visual data, audio data and/or compressed data. Any data that is to be processed or decompressed by media processing system 31 preferably can be loaded from a main memory (not shown) into DRAM and/or SDRAM, because DRAM and/or SDRAM can be accessed more rapidly due to its quicker access time. Data that has been processed by media processing system 31 may be temporarily stored in the DRAM and/or SDRAM either before being displayed on the display or before being returned to the main memory. Various memory configurations are possible in accordance with the present invention. For example, where two media processors 32 are implemented, each may have a separate internal memory, or each may share a common memory.

When processing multimedia data, media processor 32 is configured to generate a digital image data stream and a digital audio data stream. A video encoder and digital-to-analog converter (DAC) 36 converts the digital image data output from media processor 32 into analog image signals, such as composite video, s-video, component video, or the like that can be displayed on a display device, such as a television or a computer monitor. An audio digital-to-analog converter (DAC) 38 converts the digital audio signals output by media processor 32 into analog audio signals (preferably about 2-8 separate audio channels) that can be broadcast by an audio system, or the like. In accordance with an alternative embodiment, media processor 32 also may output an IEC-958 stereo audio or encoded audio data signal 39, which is an audio output signal intended for connection to systems which may have internal audio decoders or digital-to-analog converters (DACs).

Media processor 32 also may include a second storage device 37, such as a read only memory (ROM) or the like, which can be used to store a basic input/output operating system (BIOS) for media processing system 31, audio tables that may be used to decompress the audio data and generate synthesized audio, and/or any other suitable software or data used by media processor 32 and media processing system 31. Media processor 32 further may include an expansion bus 42 connected to a system bus 41, so that one or more expansion modules 43 may be connected to media processor 32. Expansion module 43 may include additional hardware, such as a microprocessor 44 for expanding the functionality of media processing system 31. As illustrated in FIG. 3, additional memory 46 also may be connected to processor 32 via expansion bus 42 and system bus 41.

As just one example, expansion module 43 may be a PC allowing interaction of a user with media processing system 31. Such interaction may include the creation of a commentary as described blow, the selection of a viddies for incorporation in a commentary, and/or storage of a custom commentary created by an end viewer.

Media processor 32 preferably includes several communication connections for communicating between media processor 32 and the rest of media processing system 31. A media data connection 50 permits the transfer of media data between media processor 32 and other systems, such as compressed image generator 19 (FIG. 2). A media control connection 52 transfers control signals and/or data between media processor 32 and other systems, such as I²C compatible devices and/or interface hardware connected to system bus 41. A user interface connection 54 transfers user interface data between media processor 32 and user interface peripherals, such as joysticks, IR remote control devices, etc. Finally, an input/output channel connection 56 allows for connections to other I/O devices for further expansion of the system.

Media processing system 31 may be used for a variety of applications, such as full-motion color video games, cable and satellite television receivers, high definition television receivers, computer systems, CD and DVD players, and the like. For example, in a video game application, digital data representing terrain, action figures, and other visual aspects of a game may be stored in main memory or input from a peripheral digital data source. In accordance with this aspect of the invention, media processing system 31, and more particularly processor 32, processes the digital data from one or more digital data sources, generating interactive full-motion color images to be displayed on a video game display. Media processing system 31 also may generate audio signals that may add music and sound effects to the video game.

For a cable or satellite television receiver, media processing system 31 decompresses compressed digital video and audio signals received from a cable head end system or satellite transmitter, and generates decompressed digital video and audio signals. The decompressed digital video and audio signals then are converted into analog signals that are output to a television display. Media processing system 31 also may be configured to decrypt any encrypted incoming cable or satellite television signals.

For a DVD player, media processing system 31 preferably receives compressed digital data from a DVD or CD, and decompresses the data. At the same time, media processing system 31 may receive digital data stored on a ROM, for example ROM 40, or input from another digital data source, and generate a video game environment in which the decompressed DVD or CD color images are displayed along with the data received from the ROM or other digital data source. Thus, an interactive, full-motion, color multimedia game may be operated by media processing system 31.

One of ordinary skill in the art will recognize that other systems are possible for processing and/or creating commentaries in accordance with the present invention. Details of other processing systems and elements thereof are provided in U.S. patent application Ser. No. 09/476,761 (Attorney Docket No. 19223-000100US), filed Jan. 3, 2000, and entitled “A Media Processing System And Method”, the entirety of which is incorporated herein by reference for all purposes; U.S. patent application Ser. No. 09/476,946 (Attorney Docket No. 19223-000600US), filed Jan. 3, 2000, and entitled “Communication Bus for a Multi-processor System”, the entirety of which is incorporated herein by reference for all purposes; U.S. patent application Ser. No. 09/476,698 (Attorney Docket No. 19223-000700US), filed Jan. 3, 2000, and entitled “Subpicture Decoding Architecture And Method”, the entirety of which is incorporated herein by reference for all purposes.

FIG. 4 is a block diagram illustrating components of a NUON™ development system 25 for creating work-in-progress and run time files in accordance with one aspect of the present invention. Development system 25 is used by an author who creates enhanced DVD titles for use in NUON™ DVD system 10, otherwise referred to as an enhancement author. In one embodiment, development system 25 comprises a personal computer 30 coupled to a NUON™ DVD reference player 40 using an Ethernet connection 50. In another embodiment, personal computer 30 could also be a hub connected to a server, such that multiple computers would have access to NUON™ DVD reference player 40. NUON™ DVD reference player 40 is coupled to a NUON™ DVD emulator 60. In some embodiments, emulator 60 obviates the need to create a digital video disc to review an authored montage. In one embodiment, NUON™ DVD emulator 60 is a storage device such as a hard drive, and is used to emulate the operation of a DVD and for storing any work-in-progress. NUON™ DVD reference player 40 is also coupled to a display 70. As shown, PC 30 is connected to certain input devices, such as, for example, joysticks 91, keyboards 92, graphics tablets 94, and microphones 93 attached to it.

Using a system such as that described in relation to FIGS. 1-4, embodiments of the present invention expand the abilities of an author of a video title to comment on various scenes in the video title or provide additional video effects that enhance the output of the video title. For example, the present invention provides an author with the ability to zoom into part of a scene to point out details of the scene, while providing a verbal description of the details. Alternatively, or in addition, the present invention provides the author with tools that allow for freezing a video title on a particular frame, drawing directly into a scene, assembling a group of viddie clips into a viddie montage, and/or making gamma correction to entire frames or portions thereof.

In some embodiments, an authoring tool in accordance with the present invention is implemented in software compiled to run on PC 30. PC 30 is connected to development system 25, such as is described in relation to FIG. 4. Various input devices attached to the PC provide a mechanism whereby an author can, using the present invention, create a commentary associated with a video title(s).

In some embodiments, the authoring tool sends events to development system 25 via PC 30. Development system 25 receives the events and displays a real-time version of the commentary under development, while simultaneously displaying back the main video title, segment and/or hyper slide. In this way, the author is provided with immediate feedback about the commentary in progress. Thus, if the author makes an error, or otherwise desires to change the commentary, the author may delete the previous comments and provide the desired comments in their place.

The authoring tool records the actions of the author in memory on PC 30. The recorded actions of the author become the commentary. For example, if the author zooms in on a particular portion of a video frame and makes a verbal comment about the portion, both the zoom and the audio will be recorded as part of the commentary. Either during production of the commentary or after the commentary is complete, the commentary can be edited by retrieving the commentary from memory and making modifications thereto.

Once the commentary is finalized and all editing is completed, the final version is stored to memory. The commentary can then be copied to a digital video disk including the video title(s) to which the commentary is related. Alternatively, the commentary can be provided via a floppy disk that is accessible by a PC operated by an end viewer and attached to an enhanced digital video disk player.

In some embodiments, the commentary includes the portions of video to which it refers. In such cases, the commentary can be run as a stand alone video title. In alternate embodiments, the commentary contains only the commands executed in relation to the video title(s) and access information for accessing the portions of the video title(s) to which the commands relate. Thus, the commentary embodied as a binary byte stream is executed by retrieving video portions indicated by the access information and performing functions on the video portions as indicated by the commands.

The byte stream is interpreted by an interpreter 17 of system 10. In some embodiments, the first byte of a series of bytes is an op-code, telling system 10 the operation to be performed as well as the number of parameters to follow in relation to the op-code. The op-code is then followed by the prescribed number of parameters. In some embodiments, the op-codes include calls specific to system 10 as well as to a 2-D graphics library. Such embodiments can be tailored for execution directly by system 10. Other embodiments can include op-codes executable by a particular environment of a PC. Such embodiments can be tailored for execution by a PC in communication with system 10.

In some embodiments, the op-codes are fixed lengths, such as eight bits. The following summarizes op-codes provided in relation to a particular embodiment of the present invention:

Timer Op-Codes

HALT—0×00

This op-code marks the end of a commentary.

TIMER EVENT—0×01

This op-code causes the commentary to pause and wait until the specified time has passed. Playback of the script will resume when the time of the video title(s) matches the specified time. The specified time is provided via a 32 bit TIME parameter passed with the op-code.

RESET TIMER—0×02

This op-code resets the timer associated with the commentary.

PAUSE TIMER—0×03

This op-code causes the timer associated with the commentary to pause.

RESUME TIMER—0×04

This op-code causes the timer associated with the commentary to resume after a pause.

Presentation Op-Codes

SET ZOOM—0×10

This op-code sets the zoom parameter associated with a particular frame or scene of the video title. A 32-bit parameter, ZOOM, is passed with the op-code indicating the amount of zoom. A factor greater than 1.0 indicates a zoom in, while a factor less than 1.0 indicates a zoom out.

SET PAN—0×11

This op-code sets the pan offsets from the center of the displayed image. It is effective only when zooming in. Two 32-bit parameters, X-OFFSET and Y-OFFSET, are passed with the op-code to indicate the offset values for the X and Y directions, respectively.

RESIZE DISPLAY WINDOW—0×12

This op-code defines a window on screen in which the displayed video is directed. In some embodiments, the effect is zoom-out, and place the zoomed result in a given location. However, this is separate from the zoom factors, which will remain at 1.0. Any future zoom in or out will be done relative to this new window and not the entire display area or screen. This op-code is followed by four 16-bit parameters, X-OFFSET, Y-OFFSET, WIDTH and HEIGHT. The parameters identify the location and size of the display window within the entire display area.

FREEZE—0×13

This op-code causes the video title to freeze at a particular frame.

RESUME—0×14

This op-code causes the video title to resume playing.

GOTO BOOKMARK—0×15

This op-code cause the commentary to continue the display at a particular point of the video title. The op-code is followed by a 96-bit parameter indicating the location of the bookmark.

GOPAST BOOKMARK—0×16

This op-code cause the commentary to continue only after a certain bookmark has been passed. The op-code is followed by a 96-bit parameter indicating the location of the bookmark.

PLAY TITLE—0×20

This op-code selects which video title will be displayed. The op-code is followed by a 32-bit parameter indicating which title number to be played. For example, where a DVD includes a main feature and a theatrical trailer, this op-code is used to select which of the main feature or the theatrical trailer will be played.

PLAY CHAPTER—0×21

This op-code causes a particular chapter of a video title to be displayed. The op-code is followed by two 32-bit parameters, TITLE NUMBER and CHAPTER, used to select the particular title and the particular chapter within the title.

PLAY—0×22

This op-code causes the video title to play.

PAUSE—0×23

This op-code causes the video title to pause.

STOP—0×24

This op-code causes the video title to stop.

FAST FORWARD—0×25

This op-code causes the video title to fast forward. When this op-code immediately follows the PLAY op-code, the video title is fast forwarded while still displaying. Otherwise, the video title is not displayed while fast forwarded.

FAST REVERSE—0×26

This op-code causes the video title to fast reverse. When this op-code immediately follows the PLAY op-code, the video title is fast reversed while still displaying. Otherwise, the video title is not displayed while fast reversed.

Graphic Engine Op-Codes

SET STYLE—0×40

This op-code sets the style of the graphic primitives. The op-code is followed by a sub-op-code, describing which kind of style (line, text, etc . . . ) to be set. In one particular embodiment, it is possible to predefine up to 255 styles for each graphics primitive. The op-code is followed by a number of parameters including, for example, parameters related to the width, color and type of lines, parameters related to the display of ellipses, text, and other graphic primitives.

DRAW POINT—0×41

This op-code causes a single point to be drawn at coordinates indicated by the 16-bit X and Y LOCATION parameters passed with the op-code.

FILL COLOR—0×42

This op-code causes a rectangle to be formed and filled with a particular color. Four 16-bit parameters, X-LOCATION, Y-LOCATION, HEIGHT and WIDTH are passed with the op-code to indicate the location of the rectangle. In addition, a 32-bit parameter is passed with the op-code indicating the color used to fill the rectangle.

DRAW LINE—0×43

This op-code causes a line to be drawn from start coordinates to end coordinates. Thus, four 16-bit parameters, XSTART, YSTART, XEND and YEND, indicating the location for the line are passed with the op-code.

DRAW STYLED LINE—0×44

This op-code causes a line of preset style to be drawn from starting coordinates to ending coordinates. The op-code is followed by an 8-bit parameter indicating the line style and four 16-bit parameters, XSTART, YSTART, XEND and YEND, indicating the location for the line.

DRAW POLY LINE—0×45

This op-code causes a closed set of lines, each beginning where the prior line left off and ending at a specified location. The op-code is followed by, among others, two 16-bit parameters indicating the center of the polygon. In addition, the op-code is followed by three 32-bit parameters indicating the X and Y scaling factors and the number of clockwise rotations. Next, is an 8-bit parameter indicating the number of sides of the polygon.

DRAW BOX—0×46

This op-code draws an unfilled rectangular box. The op-code is followed by four 16-bit parameters, X-LOCATION, Y-LOCATION, HEIGHT and WIDTH that are passed with the op-code to indicate the location of the rectangle.

DRAW ELLIPSE—0×47

This op-code draws an ellipse with a center and radius indicated by parameters passed with the op-code. More specifically, the parameters include three 16-bit parameters, XLOCATION, YLOCATION, and RADIUS.

DRAW STYLED ELLIPSE—0×48

This op-code draws an ellipse using a preset style and located according to a center and radius indicated by parameters passed with the op-code. More specifically, the parameters include three 16-bit parameters, XLOCATION, YLOCATION, and RADIUS. In addition, one 8-bit op-code is included to select the style.

CLEAR SCREEN—0×49

This op-code clears the display of all graphics primitives.

INIT 2D BOX—0×50

This op-code initializes the creation of a 2D box. The op-code is followed by an 8-bit parameter indicating the index of the box, as well as three 16-bit parameters indicating the MAXWIDTH, MAXHEIGTH and LINETHICKNESS for the box.

DRAW 2D BOX—0×51

This op-code causes a 2-D box to be drawn. Drawing the box involves creating the box in a frame buffer of a display controller, erasing the box, and then saving the pixels which must be overwritten to display the box. The op-code is followed by an 8-bit parameter indicating the box index, five 16-bit parameters indicating the WIDTH, HEIGHT, LINETHICKNESS, and the XLOCATION and YLOCATION for the box. In addition, a 32-bit parameter is passed with the op-code indicating the color of the box.

ERASE 2D BOX—0×52

This op-code erases a specified 2D box and restores the pixels that were saved when the 2D box was drawn. The op-code is followed by an 8-bit parameter indicating which box is to be erased.

REDRAW 2D BOX—0×53

This op-code re-draws a 2D box that was previously erased. The op-code is followed by an 8-bit parameter indicating which box is to be re-drawn.

RELEASE 2D BOX—0×54

This op-code releases any memory allocated to a particular box. The op-code is followed by an 8-bit parameter indicating which box is to be released from memory.

SHOW ARROW—0×60

This op-code causes an arrow, for example, a mouse pointer, to be displayed at a specified location. The op-code is followed by two 16-bit parameters indicating the X and Y coordinates where the arrow will be located and an 8-bit parameter indicating the type of arrow to be displayed.

MOVE ARROW—0×61

This op-code causes an arrow to be moved to a specified location. The op-code is followed by two 16 bit parameters indicating the XLOCATION and the YLOCATION where the arrow will be moved.

HIDE ARROW—0×62

This op-code causes the arrow to be hidden.

REDRAW ARROW—0×63

This op-code causes a hidden arrow to be re-drawn.

DRAW TEXT—0×70

This op-code draws a text string in a specified bounding rectangle using a given style. The op-code is followed by parameters indicating the text style to be displayed, the location and dimensions of the rectangle holding the text, the number of characters in the string to be displayed, and the characters in the string to be displayed.

PLAY WAVEFORM—0×80

This op-code causes a stored audio wave file to be played. The op-code is followed by a 16-bit parameter indicating the location of the stored wave file.

SYSTEM EXTENSION—0×FE

This op-code provides for any extensions. The op-code is followed by a 16-bit parameter and additional arguments as indicated by the 16-bit parameter.

NO OPERATION—0×FF

This op-code does not perform any function.

Use of the present invention is most easily described in light of various examples embodying various aspects of the present invention. FIGS. 5A and 5B illustrate an embodiment using the present invention to create a montage 110 of viddie clips derived from video title(s) 100. Referring to FIG. 5A, the parsing of a video title 100 into individual viddie clips or viddie clips 101, 102, 103, 104, 105, 106 and later assembly into montage 110 is described. In one embodiment, video title 100 may be a single movie title or it may be several video titles on a DVD. The viddie clips are then assembled to form viddie montage 110. Note in the illustration that viddie clips 101, 102, 103, 104, 105, 106 are taken from video title 100 in a scrambled order. This example illustrates that viddie clips may be pulled from any part of a title or titles, and thereafter arranged in any order in the montage. Moreover, viddie clips may be pulled from any title that appears on the DVD, including director's cuts, deleted scenes, and theatrical trailers. FIG. 5B further illustrates an individual viddie clip 101. The total run time 140 of viddie clip 101 is determined by specifying a beginning bookmark 120 and an end bookmark 130.

In an embodiment according to the present invention, montage 110 is created by developing a commentary using the aforementioned authoring tool including the described op-codes. The commentary is created by recording an author's movements through video title 100. More specifically, the commentary records the author's movements as they select viddie clip 103, then viddie clip 101, then viddie clip 102 and so on for assembly into montage 110. These movements through video title 100 are recorded as the commentary, or byte stream of op-codes and parameters. Playback of the commentary will cause viddie montage 110 to play. One of ordinary skill in the art will recognize that a number of different assemblages of op-codes are possible to form montage 110 as illustrated.

In a particular embodiment, the commentary for causing montage 110 to play includes the following twenty-five instructions described in their text form rather than the op-code form that would represent the executable commentary:

1. RESIZE DISPLAY WINDOW [Parameters]: sets up the window for displaying montage 110

2. GOTO BOOKMARK [Parameter]: causes the playback to begin at the start of viddie clip 103

3. PLAY: causes video title 100 to begin playing at viddie clip 103

4. GOPAST BOOKMARK [Parameter]: continues playing video title 100 to the end of segment 103

5. STOP :causes video title 100 to stop playing after the previous bookmark is reached

6. GOTO BOOKMARK [Parameter]: causes the playback to start again at the start of viddie clip 101

7. PLAY: causes video title 100 to begin playing at viddie clip 101

8. GOPAST BOOKMARK [Parameter]: continues playing video title 100 to the end of segment 101

9. STOP :causes video title 100 to stop playing after the previous bookmark is reached

10. GOTO BOOKMARK [Parameter]: causes the playback to start again at the start of viddie clip 102

11. PLAY: causes video title 100 to begin playing at viddie clip 102

12. GOPAST BOOKMARK [Parameter]: continues playing video title 100 to the end of segment 102

13. STOP :causes video title 100 to stop playing after the previous bookmark is reached

14. GOTO BOOKMARK [Parameter]: causes the playback to start again at the start of viddie clip 105

15. PLAY: causes video title 100 to begin playing at viddie clip 105

16. GOPAST BOOKMARK [Parameter]: continues playing video title 100 to the end of segment 105

17. STOP :causes video title 100 to stop playing after the previous bookmark is reached

18. GOTO BOOKMARK [Parameter]: causes the playback to start again at the start of viddie clip 106

19. PLAY: causes video title 100 to begin playing at viddie clip 106

20. GOPAST BOOKMARK [Parameter]: continues playing video title 100 to the end of segment 106

21. STOP :causes video title 100 to stop playing after the previous bookmark is reached

22. GOTO BOOKMARK [Parameter]: causes the playback to start again at the start of viddie clip 104

23. PLAY: causes video title 100 to begin playing at viddie clip 104

24. GOPAST BOOKMARK [Parameter]: continues playing video title 100 to the end of segment 104

25. HALT

To create such a commentary, the author would fast forward to the various points in the video title and identify the particular bookmarks designating the viddie clip locations. In some embodiments, this is done by reading the timer associated with video 100 and associating the start and stop points for the various viddie clips with the value on the timer. In other embodiments, the Time Op-Codes as described above can be used to perform a similar marking function. The movements of the author through video title 100 as they create the commentary can be automatically recorded. The author can then edit the recorded commentary to remove portions that are not desirable. In addition, in some embodiments, automatic editing of the commentary can be provided to remove extraneous instructions. For example, where the author marks bookmarks for the beginning, end and center of viddie clip 101 and indicates that viddie clip 101 should play from the beginning bookmark to the end bookmark, the center bookmark and any interim play command can be removed as extraneous.

Montage 110 can be further enhanced by recording an author's verbal commentary about each of the viddie clips for replay with the montage. As just an example, each of viddie clips 101, 102, 103, 104, 105, 106 can be played through and paused at the end where the author's verbal commentary on the viddie clip is played for the viewer. The following commentary including thirty-two instructions could be implemented to provide the aforementioned montage:

1. RESIZE DISPLAY WINDOW [Parameters]: sets up the window for displaying montage 110

2. GOTO BOOKMARK [Parameter]: causes the playback to begin at the start of viddie clip 103

3. PLAY: causes video title 100 to begin playing at viddie clip 103

4. GOPAST BOOKMARK [Parameter]: continues playing video title 100 to the end of segment 103

5. PAUSE: causes video title 100 to pause playing after the previous bookmark is reached

6. PLAY WAVEFORM [Parameter]: play the author's audio description of viddie clip 103

7. GOTO BOOKMARK [Parameter]: causes the playback to begin at the start of viddie clip 101

8. PLAY: causes video title 100 to begin playing at viddie clip 101

9. GOPAST BOOKMARK [Parameter]: continues playing video title 100 to the end of segment 101

10. PAUSE :causes video title 100 to pause playing after the previous bookmark is reached

11. PLAY WAVEFORM [Parameter]: play the author's audio description of viddie clip 101

12. GOTO BOOKMARK [Parameter]: causes the playback to begin at the start of viddie clip 102

13. PLAY: causes video title 100 to begin playing at viddie clip 102

14. GOPAST BOOKMARK [Parameter]: continues playing video title 100 to the end of segment 102

15. PAUSE: causes video title 100 to pause playing after the previous bookmark is reached

16. PLAY WAVEFORM [Parameter]: play the author's audio description of viddie clip 102

17. GOTO BOOKMARK [Parameter]: causes the playback to begin at the start of viddie clip 105

18. PLAY: causes video title 100 to begin playing at viddie clip 105

19. GOPAST BOOKMARK [Parameter]: continues playing video title 100 to the end of segment 105

20. PAUSE: causes video title 100 to pause playing after the previous bookmark is reached

21. PLAY WAVEFORM [Parameter]: play the author's audio description of viddie clip 105

22. GOTO BOOKMARK [Parameter]: causes the playback to begin at the start of viddie clip 106

23. PLAY: causes video title 100 to begin playing at viddie clip 106

24. GOPAST BOOKMARK [Parameter]: continues playing video title 100 to the end of segment 106

25. PAUSE: causes video title 100 to pause playing after the previous bookmark is reached

26. PLAY WAVEFORM [Parameter]: play the author's audio description of viddie clip 106

27. GOTO BOOKMARK [Parameter]: causes the playback to begin at the start of viddie clip 104

28. PLAY: causes video title 100 to begin playing at viddie clip 104

29. GOPAST BOOKMARK [Parameter]: continues playing video title 100 to the end of segment 104

30. PAUSE: causes video title 100 to pause playing after the previous bookmark is reached

31. PLAY WAVEFORM [Parameter]: play the author's audio description of viddie clip 104

32. HALT

Viddie montage 110 adds value to a DVD title by creating thematic montages of viddie clips. For example, a montage could be compiled for explosions in an action film, or kisses in a romantic drama, or explosive-corrosive-acid-soaked-kisses in a sci-fi thriller. For example, assume a studio is putting out a sci-fi thriller and wants to assemble a kissing viddie montage. All the kissing parts of the film would be identified as well as their respective DVD run-times 140, including the beginning bookmark 120 and the ending bookmark 130. This identification and compilation generates a run list for a single viddie montage 110 with each of the kissing scenes, which are viddie clips, and their individual in and out time codes.

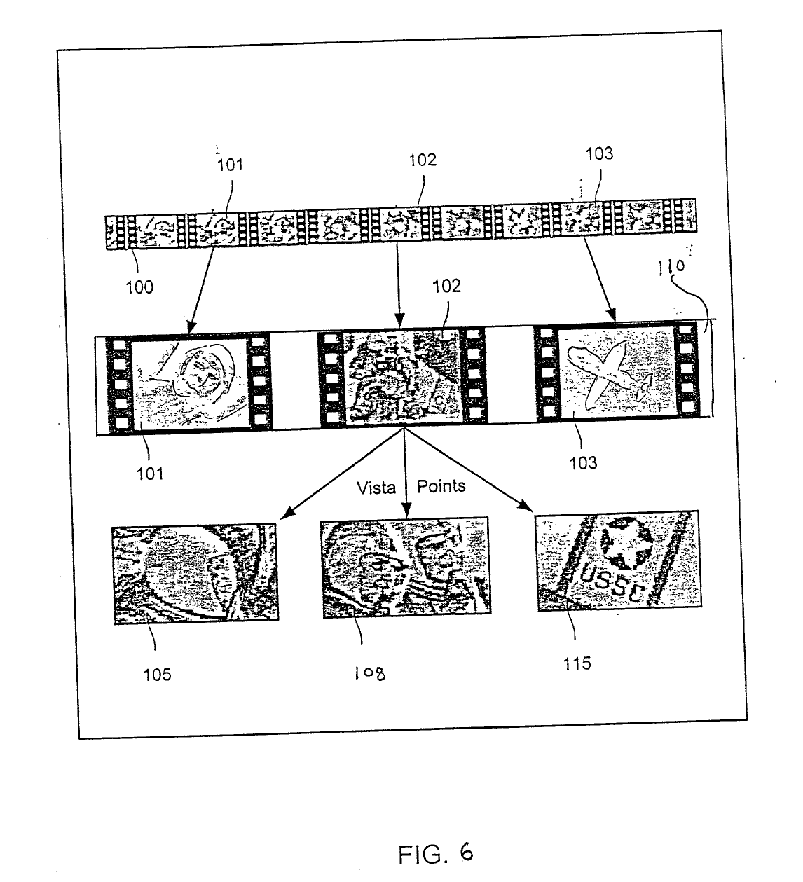

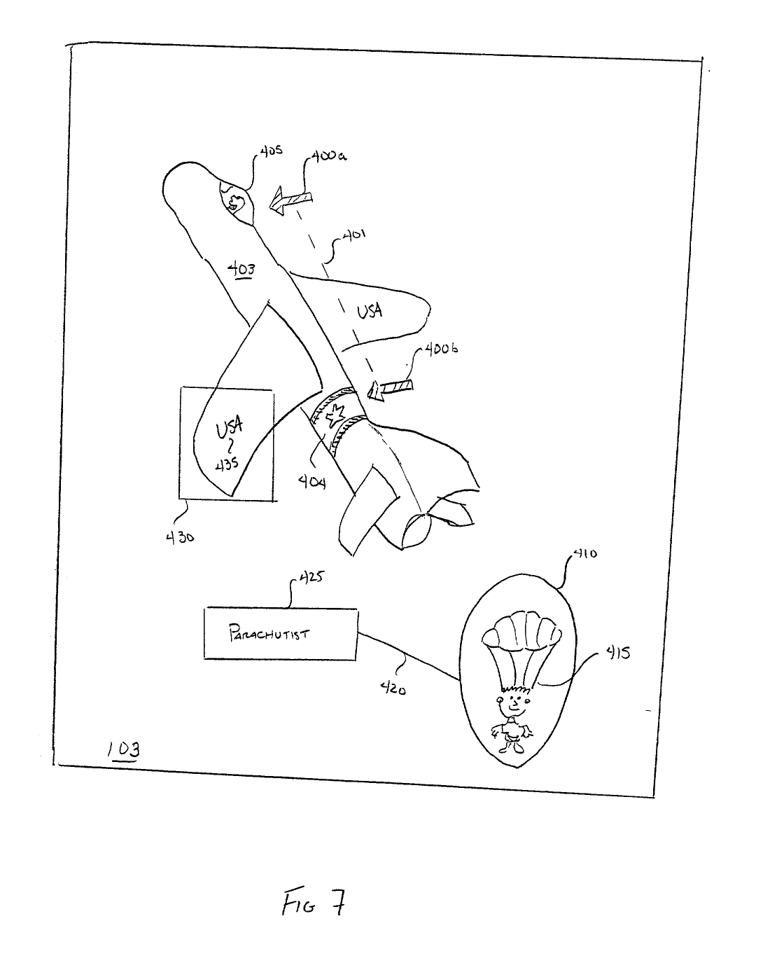

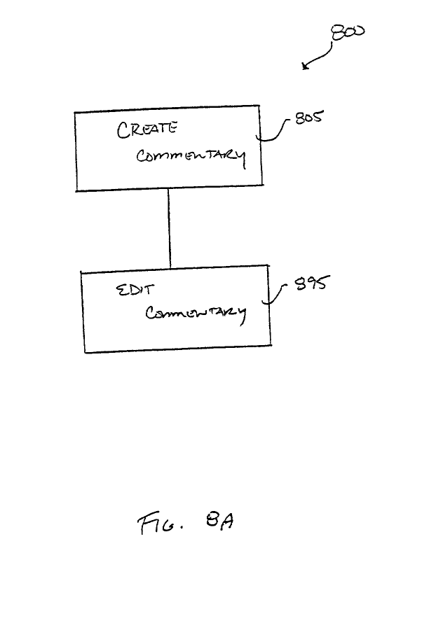

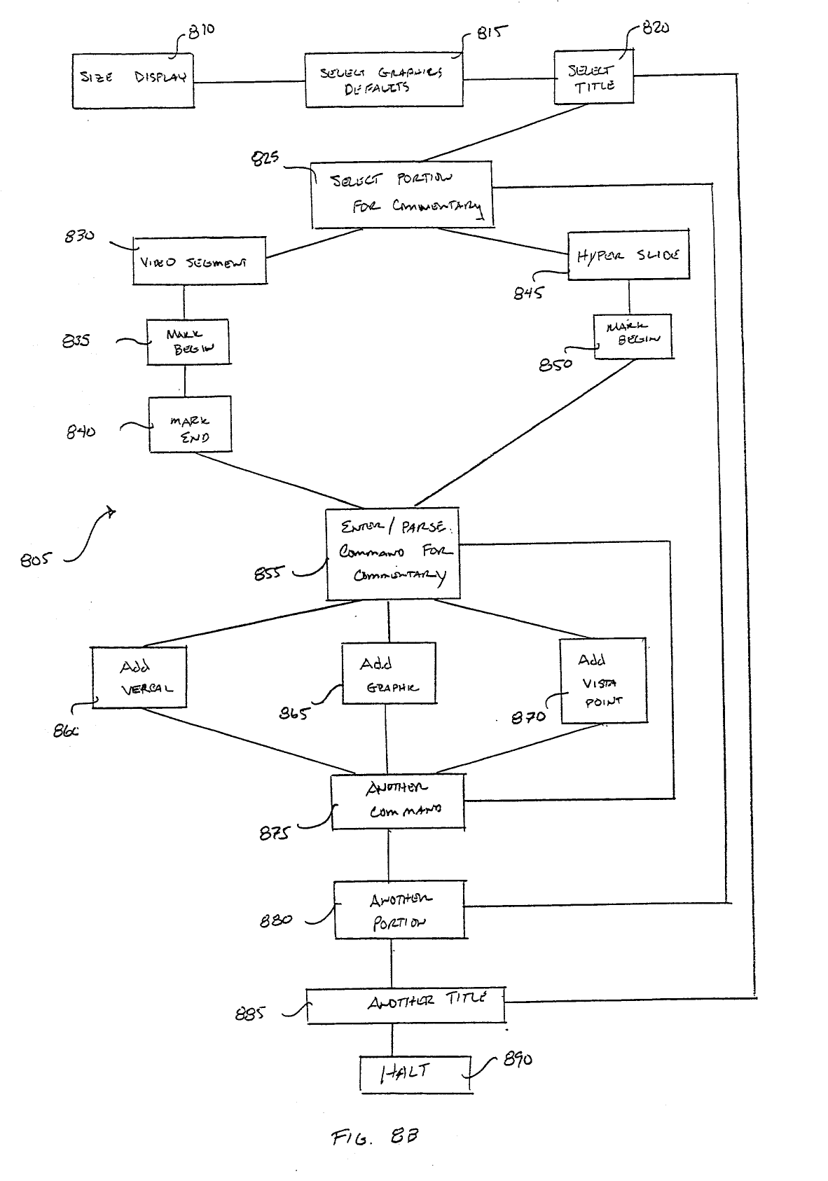

In some embodiments, the minimum run time for a viddie clip is one video frame. Thus, the system can be used to create still images from digital video title 100. Such still images can be used to create a hyper slide of a scene from video title 100. Referring to FIG. 6, an embodiment creating a montage 110 of hyper slides 101, 102, 103 is described. Video title 100 includes viddie clips 101, 102, 103 where each of the viddie clips is a single frame of video title 100. Thus, viddie clips 101, 102, 103 are in the form of hyper slides. Montage 110 can be created using the following commentary:

1. RESIZE DISPLAY WINDOW [Parameters]: sets up the window for displaying montage 110

2. GOTO BOOKMARK [Parameter]: causes the playback to begin at the start of hyper slide 101

3. FREEZE: causes video title 100 to freeze with hyper slide 101 displayed

4. TIMER EVENT [Parameter]: causes the hyper slide 101 to remain displayed for a specified period

5. GOTO BOOKMARK [Parameter]: causes the playback to begin at the start of hyper slide 102

6. FREEZE: causes video title 100 to freeze with hyper slide 102 displayed

7. TIMER EVENT [Parameter]: causes the hyper slide 102 to remain displayed for a specified period

8. GOTO BOOKMARK [Parameter]: causes the playback to begin at the start of hyper slide 103

9. FREEZE: causes video title 100 to freeze with hyper slide 103 displayed

10. TIMER EVENT [Parameter]: causes the hyper slide 103 to remain displayed for a specified period

11. HALT

Montage 110 described in relation to FIG. 6 can be further enhanced by providing detailed views of the various hyper slides 101, 102, 103. As illustrated, hyper slide 102 is decomposed into component parts to view various details, or vista points 105, 108, 110, of hyper slide 102. These vista points can be zoomed portions of hyper slide 102. This provides the end viewer with the opportunity to understand the detail and care that went into developing video title 100. Montage 110 including vista points 105, 108, 115 can be created using the following commentary:

1. RESIZE DISPLAY WINDOW [Parameters]: sets up the window for displaying montage 110

2. GOTO BOOKMARK [Parameter]: causes the playback to begin at the start of hyper slide 101

3. FREEZE: causes video title 100 to freeze with hyper slide 101 displayed

4. TIMER EVENT [Parameter]: causes the hyper slide 101 to remain displayed for a specified period

5. GOTO BOOKMARK [Parameter]: causes the playback to begin at the start of hyper slide 102

6. FREEZE: causes video title 100 to freeze with hyper slide 102 displayed

7. TIMER EVENT [Parameter]: causes the hyper slide 102 to remain displayed for a specified period

8. SET ZOOM [Parameters]: zooms in sufficiently to display an area the size of vista point 105

9. SET PAN [Parameters]: pans to the portion of hyper slide 102 containing the image of vista point 105

10. TIMER EVENT [Parameter]: causes hyper slide 105 to remain displayed for a specified period

11. SET ZOOM [Parameters]: zooms in sufficiently to display an area the size of vista point 108

12. SET PAN [Parameters]: pans to the portion of hyper slide 102 containing the image of vista point 108

13. TIMER EVENT [Parameter]: causes hyper slide 108 to remain displayed for a specified period

14. SET ZOOM [Parameters]: zooms in sufficiently to display an area the size of vista point 115

15. SET PAN [Parameters]: pans to the portion of hyper slide 102 containing the image of vista point 115

16. TIMER EVENT [Parameter]: causes hyper slide 115 to remain displayed for a specified period

17. GOTO BOOKMARK [Parameter]: causes the playback to begin at the start of hyper slide 103

18. FREEZE: causes video title 100 to freeze with hyper slide 103 displayed

19. TIMER EVENT [Parameter]: causes the hyper slide 103 to remain displayed for a specified period

20. HALT

Other embodiments can provide for the author's verbal discussion of, for example, vista point 108. Such an embodiment is provided using the following set of instructions:

1. RESIZE DISPLAY WINDOW [Parameters]: sets up the window for displaying montage 110

2. GOTO BOOKMARK [Parameter]: causes the playback to begin at the start of hyper slide 101

3. FREEZE: causes video title 100 to freeze with hyper slide 101 displayed

4. TIMER EVENT [Parameter]: causes the hyper slide 101 to remain displayed for a specified period

5. GOTO BOOKMARK [Parameter]: causes the playback to begin at the start of hyper slide 102

6. FREEZE: causes video title 100 to freeze with hyper slide 102 displayed

7. TIMER EVENT [Parameter]: causes the hyper slide 102 to remain displayed for a specified period

8. SET ZOOM [Parameters]: zooms in sufficiently to display an area the size of vista point 105

9. SET PAN [Parameters]: pans to the portion of hyper slide 102 containing the image of vista point 105

10. TIMER EVENT [Parameter]: causes hyper slide 105 to remain displayed for a specified period

11. SET ZOOM [Parameters]: zooms in sufficiently to display an area the size of vista point 108

12. SET PAN [Parameters]: pans to the portion of hyper slide 102 containing the image of vista point 108

13. PLAY WAVEFORM [Parameter]: play the author's audio description of vista point 108

14. TIMER EVENT [Parameter]: causes hyper slide 108 to remain displayed for a specified period

15. SET ZOOM [Parameters]: zooms in sufficiently to display an area the size of vista point 115

16. SET PAN [Parameters]: pans to the portion of hyper slide 102 containing the image of vista point 1 15

17. TIMER EVENT [Parameter]: causes hyper slide 115 to remain displayed for a specified period

18. GOTO BOOKMARK [Parameter]: causes the playback to begin at the start of hyper slide 103

19. FREEZE: causes video title 100 to freeze with hyper slide 103 displayed

20. TIMER EVENT [Parameter]: causes the hyper slide 103 to remain displayed for a specified period

21. HALT

In yet other embodiments, viddie clips (or hyper slides) 101, 102, 103 and/or vista points 105, 108, 115 can be marked using 2D graphics instructions. Such marking can be placed over multiple frames of a viddie clip or over a single frame hyper slide. Referring to FIG. 7, an example of a 2D graphics markup of hyper slide 103 is described. As illustrated, hyper slide 103 comprises an aircraft 403 and a parachutist 415. Aircraft 403 includes a canopy 405, a star marking 404, and a country designation 435. Provided graphically with hyper slide 103 are an arrow 400 that is moved from point 400a where it designates canopy 405 to point 400b where it designates star marking 404. In addition, an outline box 430 surrounds country designation 435. An ellipse 410 surrounds parachutist 415 and a line 420 goes from ellipse 410 to text box 425. Text box 425 can include a text string describing parachutist 415.

The 2D graphics can be displayed over hyper slide 103 all at one time, or they can be displayed one at a time such that the prior 2D graphics are removed before adding the next 2D graphics. Alternatively, the 2D graphics can be displayed incrementally, for example, by adding ellipse 410, text box 425 and line 420 first followed by an explanation of parachutist 415. Then, without erasing the aforementioned graphics, box 430 can be added followed by a description of the country designation. One of ordinary skill in the art will appreciate that any number of combinations are possible in accordance with the present invention.

Arrow 400 can be moved to different locations. Thus, for example, arrow 400 could be moved to point 400a followed by a discussion of canopy 405 and subsequently moved to point 400b and followed by a description of star marking 404. Dashed line 401 indicates the path along which arrow 400 moves. In some embodiments, arrow 400 is erased at position 400a and re-appears at position 400b. In other embodiments, arrow 400 is visible as it moves from position 400a to position 400b along path 401.

Box 430 can be used to designate a portion to be selected, zoomed and panned to create a vista point as previously discussed. Thus, for example, hyper slide 103 could be displayed and subsequently have box 430 drawn thereon. The viewer would thus see hyper slide 103 including box 430 surrounding country designation 435. Then, after a period of time, the portion of hyper slide 103 incorporated in box 430 could be re-displayed as a vista point. Thus, the viewer would only see country designation 435 on the wing of aircraft 403.

The graphics can be created using a joystick, graphics tablet or other suitable computer input device. The inputs from the computer input devices can be automatically recorded as part of a commentary. The commentary is then later edited to create the final commentary. An exemplary commentary causing the graphics elements of FIG. 7 to display is provided below:

1. RESIZE DISPLAY WINDOW [Parameters]: sets up the window for displaying hyper slide 103

2. GOTO BOOKMARK [Parameter]: causes the playback to begin at the start of hyper slide 103

3. FREEZE: causes video title 100 to freeze with hyper slide 103 displayed

4. SHOW ARROW [Parameters]: causes arrow 400 to be drawn at position 400a

5. DRAW 2D BOX [Parameters]: causes box 430 to be displayed surrounding designation 435

6. DRAW ELLIPSE [Parameters]: causes ellipse 410 to be displayed surrounding parachutist 415

7. DRAW TEXT [Parameters]: causes text box 425 with the associated text string to be displayed

8. DRAW LINE [Parameters]: causes line 420 to be displayed from ellipse 410 to text box 425

9. TIMER EVENT [Parameter]: causes the hyper slide 103 to remain displayed for a specified period

10. MOVE ARROW [Parameters]: causes arrow 400 to be moved from position 400a to position 400b

11. TIMER EVENT [Parameter]: causes the hyper slide 103 to remain displayed for a specified period

12. HALT

Each of the 2D graphics can be displayed either coincident with, preceding, or following a verbal description of the significance of the added graphic of the portion of hyper slide 103 designated by the particular graphic. Thus, it will be appreciated by one of ordinary skill in the art that a myriad of possibilities exist for marking or otherwise designating portions of video title 100. Such designations in the form of a commentary can be executed by a viewer to provide an enhanced understanding of video title 100. Embodiments according to the present invention thus provide an author with an ability to create director's scripts tailored for viewers.

FIGS. 8A and 8B illustrate a flow chart 800 comprising steps for creating a commentary in accordance with the present invention. Referring to FIG. 8A, the steps include creating a commentary (805) and editing the commentary (895). FIG. 8B details the steps involved in one embodiment of creating a commentary (805).

Referring to FIG. 8B, the commentary is created by first initializing and sizing the display window (810) into which the commentary will ultimately be presented. The indication of the video title is recorded in the commentary as op-codes followed by associated parameters. Then, the default parameters for the graphics primitives are set (815). As previously discussed, the graphics primitives can include line widths, line and fill colors, arrow styles etc. The selections for the graphics primitives is recorded in the commentary as an op-code followed by the specific parameters. After the graphics are set (815), the video title that will form the basis of the commentary is selected (820).

Next, the viddie clip of the selected video title (820) that will be commented upon is identified (825). In some embodiments, marking the portion is different for viddie clips than for hyper slides. Marking a viddie clip (830) includes marking the beginning (835) and the ending (840). Marking can be done by indicating the time at which the segment begins and ends, or providing any other suitable indication of the beginning and end. Marking hyper slides (845) includes marking the beginning (850) of the frame. The selecting and marking of the viddie clip or hyper slide is recorded in the commentary as op-codes followed by associated primitives.

After the viddie clip to be commented upon has been selected (825), various commands are received in relation to the selected portion (855). The commands are parsed (855) and handled in one or more command steps (860, 865, 870). For example, where a line is drawn on a graphics tablet from, as illustrated in FIG. 7, parachutist 415 to text box 425, the op-codes and associated parameters for replicating that line on a display are recorded in the commentary by the add graphic step (865).

Alternatively, where the author desires to make a verbal commentary about the selected segment, it is added in an add verbal step (860). In step 860, the author speaks into a microphone and the comments are recorded and stored on a PC at a particular address as a wave file. In addition, op-codes causing the wave file to be retrieved and played are recorded in the commentary. Ultimately, in various embodiments, the commentary, as well as the wave files are stored on a DVD with the associated video title(s).

As yet another alternative, an author desiring to create a vista point can do so using the add vista point step (870). In some embodiments, to create a vista point, the author selects a section of a particular viddie clip by marking it using a graphic tablet. The author then indicates that the selected section should be treated as a vista point. This action by the author causes op-codes for zooming and panning, along with the associated parameters, to be recorded in the commentary.

After a command is entered, parsed and recorded in the commentary (855, 860, 865, 870) the author is queried to determine if additional commands are to be entered in relation to the selected viddie clip (875). Alternatively, the application can simply assume that the author will input an additional command until the author explicitly indicates that they are finished. Where the author enters another command (875), the entered command is parsed and handled as described in relation to steps 855, 860, 865, 870. This loop repeats until the author is finished entering commands in relation to the selected viddie clip.

Once the author is finished entering commands in relation to the selected viddie clip, they are queried whether they would like to choose an additional viddie clip from the same video title to add to the commentary (880). If the author desires to select and comment on an additional segment, the author is returned to step 825, and the steps of 825 through 880 are repeated for the next viddie clip. This process repeats until the author is finished with all desired viddie clips from the video title.

Once the author is finished commenting on viddie clips of the video title, they are queried whether they would like to choose an additional video title from which to choose viddie clips for comment (885). If the author desires to comment on viddie clips of another video title, the author is returned to step 820, and the steps of 820 through 885 are repeated for the next video title. This process repeats until the author is finished with all desired video titles.

When the author has finished with all desired video titles, a HALT command is inserted in the commentary (890). At this point, the commentary is complete and ready for final editing. The commentary exists as a byte stream of op-codes representing the recorded commands and selections followed by any associated parameters specifying the details of the recorded commands. In the editing process, the created commentary can be augmented by adding other created commentaries, deleted from, re-ordered, or modified in other ways.

At this juncture, one of ordinary skill in the art will recognize that other command steps and/or commands are possible in accordance with the present invention. Thus, the foregoing description should not interpreted to limit in any way the type or scope of commands possible.

In some embodiments, editing the commentary (895) includes creating a text file of the commentary from the binary byte stream stored while creating the commentary (805), and editing the text file. The text file is created by reverse compiling the commentary. An example of such a text file commentary includes one command per line of text with the command name displayed along with the op-code. The parameters associated with each command are displayed one parameter per line and slightly indented in an area below the associated command. In some embodiments, the parameter names are displayed with a description of the type and value.

The text file can be edited using any text editor to modify the commentary and receive the desired result. In some embodiments, commands associated with particular video titles, viddie clips and/or hyper slides are grouped apart from commands associated with other video titles, viddie clips and hyper slides. This helps the editor identify the commands to be modified. Additionally, some embodiments provide for naming the videos or hyper slides during commentary creation 805. In such embodiments, the name of the video title, viddie clip and/or hyper slide can be displayed along with the commands associated therewith to provide for easy access during editing. After the editing is completed, the text file can be compiled to a byte stream of op-codes and parameters suitable for execution as a finalized commentary.

It is thought that the apparatuses and methods of the embodiments of the present invention and many of its attendant advantages will be understood from this specification and it will be apparent that various changes may be made in the form, construction and arrangement of the parts thereof without departing from the spirit and scope of the invention or sacrificing all of its material advantages, the form herein before described being merely exemplary embodiments thereof.

What is claimed is:

1. A method for providing an annotated video title, the method comprising:
identifying a segment of a video title;
providing an annotation associated with the segment of the video title;
formatting the annotation as a computer readable op-code; and
storing the computer readable op-code as part of a commentary associated with the video title.

2. The method of claim 1, wherein the commentary is executable by a computer to provide an enhanced version of the video title.

3. The method of claim 1, wherein the video title is a first video title, the computer readable op-code is a first computer readable op-code, and the annotation is a first annotation, the method further comprising:
identifying a segment of a second video title;
providing a second annotation associated with the segment of the second video title;
formatting the second annotation as a second computer readable op-code; and
storing the second computer readable op-code as part of the commentary associated with the first and second video titles.

4. The method of claim 3, the method further comprising:
storing the commentary on a digital video disk with the first and second video titles.

5. The method of claim 1, wherein the segment of the video title is a first segment of the video title, the computer readable op-code is a first computer readable op-code, and the annotation is a first annotation, the method further comprising:
identifying a second segment of the video title;
providing a second annotation associated with the second segment of the video title;
formatting the second annotation as a second computer readable op-code; and
storing the second computer readable op-code as part of the commentary associated with the video title.

6. The method of claim 1, the method further comprising:
reverse compiling the commentary to create a textual commentary, wherein the computer readable op-code is formatted as a text string indicating the function of the op-code; and
modifying the text string of the textual commentary; and
compiling the textual commentary to create a computer executable commentary.

7. The method of claim 6, wherein the computer executable commentary is stored on a digital video disk with the video title.

8. The method of claim 6, wherein the op-code further comprises a parameter and modifying the text string comprises modifying the parameter.

9. The method of claim 1, wherein the providing the annotation comprises providing a command via an input device selected from a group consisting of a graphics tablet, a keyboard, a joystick and a microphone.

10. The method of claim 9, wherein the formatting the annotation as a computer readable op-code comprises:
receiving the command via the input device; and
using a software interpreter, translating the command directly to the computer readable op-code.

11. The method of claim 1, wherein the annotation is provided in the form of a command and the command is selected from a group consisting of and add verbal command, an add graphic command and an add vista point command, the method further comprising:
parsing the command to determine if the command is an add graphic command, an add verbal command and/or and add vista point command.

12. The method of claim 11, wherein the command is an add graphic command, and wherein the computer readable op-code is executable to display a graphic associated with the segment of the video title.

13. The method of claim 11, wherein the command is an add verbal command, and wherein the computer readable op-code is executable to play an audio recording associated with the segment of the video title.

14. The method of claim 11, wherein the command is an add vista point command, and wherein the computer readable op-code is executable to display a vista point associated with the segment of the video title.

15. As system for creating commentaries associated with video titles, the system comprising:
a display;
an interpreter for receiving commands from an input device, wherein the commands comprise commands selected from a group consisting of an add verbal command, an add graphic command and an add vista point command, and wherein the commands are associated with a video title presented on the display; and
a memory element storing a computer executable code operable to:
receive the commands from the interpreter;
indicate a segment of the video title; and
format the commands as a computer executable commentary associated with the segment of the video title.

16. The system of claim 15, the system further comprising:
an emulator for presenting the commentary to the display.

17. The method of claim 16, wherein the display comprises a first display window and a second display window, and wherein at least a portion of the video title is displayed in the first display window absent annotations and the commentary is displayed in the second display window, and wherein the commentary as displayed comprises at least a portion of the video title and an associated annotation.

18. A system for presenting commentaries associated with one or more video titles, the system comprising:
a memory storage device comprising a commentary and a video title; and
a microprocessor based player for retrieving portions of the commentary and portions of the video title and for causing a presentation to display, wherein the presentation comprises images from the video title and annotations directed from the commentary.

19. The system of claim 18, wherein the presentation comprises a frame from the video title overlaid with graphics.

20. The method of claim 18, wherein the presentation comprises a viddie clip from the video title presented coincident with a verbal statement describing the viddie clip, and wherein the verbal statement is presented under control of the commentary.
